(19) United States
(12) Patent Application Publication
(10) Pub. No.: US 2016/0291050 A1
(43) Pub. Date: Oct. 6, 2016

(54) Inertial Sensor

(71) Applicant: ROBERT BOSCH GMBH, Stuttgart (DE)

(72) Inventors: Ricardo Ehrenpfordt, Korntal-Muenchingen (DE); Daniel Pantel, Ditzingen (DE); Frederik Ante, Stuttgart (DE)

(73) Assignee: ROBERT BOSCH GMBH, Stuttgart (DE)

(21) Appl. No.: 15/035,459

(22) PCT Filed: Oct. 28, 2014
(86) PCT No.: PCT/EP2014/073047

§ 371 Date: May 9, 2016

(30) Foreign Application Priority Data
Nov. 12, 2013 (DE) 10 2013 222 966.6

(51) Int. Cl. G01P 1/00; G01C 19/5783

(52) U.S. Cl. CPC G01P 1/003; G01C 19/5783; G01P 2015/0882

(57) ABSTRACT

An inertial sensor includes a first sensor element, which is damped against vibrations from an interface of the inertial sensor by a damping element. The first sensor element is configured to detect a first measured variable in a first frequency band, and the damping element is configured to dampen vibrations at least in the first frequency band. The inertial sensor further includes a second sensor element, which is mechanically coupled to the interface. The second sensor element is configured to detect a second measured variable in a second frequency band.

### PRIOR ART

The present invention relates to an inertial sensor.

Inertial sensors are used to detect accelerations and rotation rates. In this context, there is a trend toward arranging the inertial sensors in ever-smaller packages.

DE 10 2010 029 709 A1 describes a microelectromechanical component.

### DISCLOSURE OF THE INVENTION

Against this background, with the approach proposed here, an inertial sensor according to the main claim is provided. Advantageous configurations may be found in the respective dependent claims and the description below.

Different types of inertial sensor elements can be operated in different frequency ranges. In the various frequency ranges, different types of fastening for the inertial sensor elements have different damping properties. Advantageously, in an inertial sensor having a plurality of different sensor elements, each individual sensor element can be fastened in such a way that its specific type of fastening has good damping properties in the frequency range of the sensor element. In this way, signals of the sensor elements of the inertial sensor can have a minimal superposition of parasitic vibrations. Because of the low superposition, events to be detected can be represented with little interference in the signals and evaluated with high reliability.

An inertial sensor having the following features is provided:

a first sensor element, which is vibrationally damped in relation to an interface of the inertial sensor, the first sensor element being configured in order to detect a first measurement quantity in a first frequency band and the damping element being configured in order to damp vibrations in at least the first frequency band; and

a second sensor element, which is mechanically coupled to the interface, the second sensor element being configured in order to detect a second measurement quantity in a second frequency band.

An inertial sensor may be understood as a sensor for detecting at least one acceleration and/or at least one rotation rate. The inertial sensor may be configured in order to detect accelerations along a plurality of axes angularly offset with respect to one another and/or rotation rates about a plurality of axes angularly offset with respect to one another. The inertial sensor may be configured in order to detect accelerations in three spatial directions and/or rotation rates about the three spatial directions. The first sensor element may have a first working point in the first frequency band. For example, at least one sensor body of the first sensor element may be made to vibrate with a first frequency within the first frequency band. The second sensor element may have a second working point in the second frequency band. For example, at least one sensor body of the second sensor element may be made to vibrate with a second frequency within the second frequency band. The damping element may be configured in order to pass on an amplitude of an interference vibration in a reduced fashion to the first sensor element at least within the first frequency range.

The first sensor element and/or the second sensor element may be configured in a multiaxial fashion. In this way, the first measurement quantity and/or the second measurement quantity can be detected in a plurality of spatial directions.

The first sensor element may be coupled without damping to the interface. The inertial sensor may have a smaller amplitude amplification of the exciting vibrations within the first frequency range in the undamped state than in the damped state.

The damping element can be configured as a flexible beam structure which connects a part, coupled to the interface, of the inertial sensor to a vibratable part of the inertial sensor, the first sensor element being connected to the vibratable part. The beams of the beam may be configured as flexural springs. The longer the beams are, the more softly the second sensor element can be mounted.

The beam structure may bridge a gap which is arranged between an annularly circumferential ring, coupled to the interface, of the inertial sensor and a vibratable island, a beam of the beam structure connecting a side surface of the island to an inner surface, oriented transversely to the side surface, of the ring. By the connection of surfaces oriented transversely with respect to one another, the beams can execute movements in a plurality of spatial directions. In this way, vibrations in a plurality of spatial directions can also be damped.

An additional soft material may be arranged between the beams of the beam structure. By virtue of the material, the damping system can be configured optimally, and in particular the amplitude of the resonant vibration can be reduced. As a result of processing, the damping material may also protrude slightly from the substrate plane or be set back below the substrate plane. The damping material may fully cover the beams, the island and partially the frame on at least one side of the substrate plane.

The inertial sensor may have a first substrate layer and at least a second substrate layer, the substrate layers being arranged in different planes, and the first sensor element being arranged on the first substrate layer and the second sensor element being arranged on the second substrate layer. By arrangement of the sensor elements above one another, the sensor element suspended with damping can be protected by the undamped sensor element of the inertial sensor.

At least one central substrate layer may be arranged between the first substrate layer and the second substrate layer, the central substrate layer separating the first substrate layer from the second substrate layer and forming a cavity between the first substrate layer and the second substrate layer. By virtue of an additional central substrate layer, a cavity as a space for movements of the first sensor element can be provided in a straightforward way.

The substrate layers may be connected to one another by means of solder balls, the solder balls forming an electrical contact and/or a mechanical contact. A material-fit contact can be achieved by using solder balls.

A sealing device for sealing the cavity may be arranged between the substrate layers. The sealing device may protect the first sensor element from contamination.

At least one of the substrate layers may have an annularly circumferential foot in order to define a distance between the substrate layers and form the cavity. The foot may define a defined distance between the substrate layers.

The first sensor element and the second sensor element may be arranged on a substrate. A small overall height of the inertial sensor can be achieved by arrangement next to one another.

The first sensor element and/or the second sensor element may have an integrated circuit for processing sensor signals of the first sensor element and/or of the second sensor element. By using an integrated circuit, the sensor signal can be filtered. Rotation rates and/or accelerations to be detected can be detected reliably by virtue of the filtering.

The first sensor element may be an acceleration sensor and the second sensor element may be a rotation rate sensor, or vice versa.

The approach proposed here will be explained in more detail below by way of example with the aid of the appended drawings, in which:

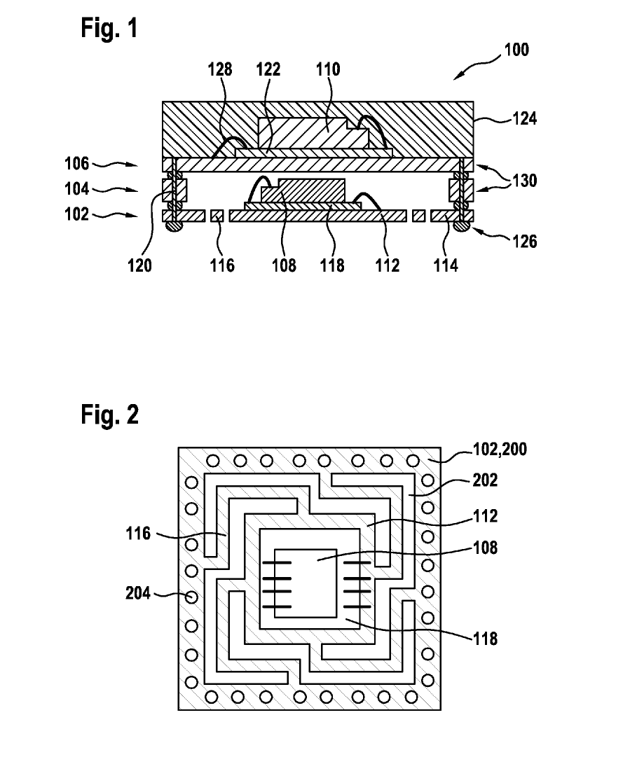

FIG. 1 shows a sectional representation of an inertial sensor according to one exemplary embodiment of the present invention;

FIG. 2 shows a representation of a lower substrate layer having a damping element and a first sensor element according to one exemplary embodiment of the present invention;

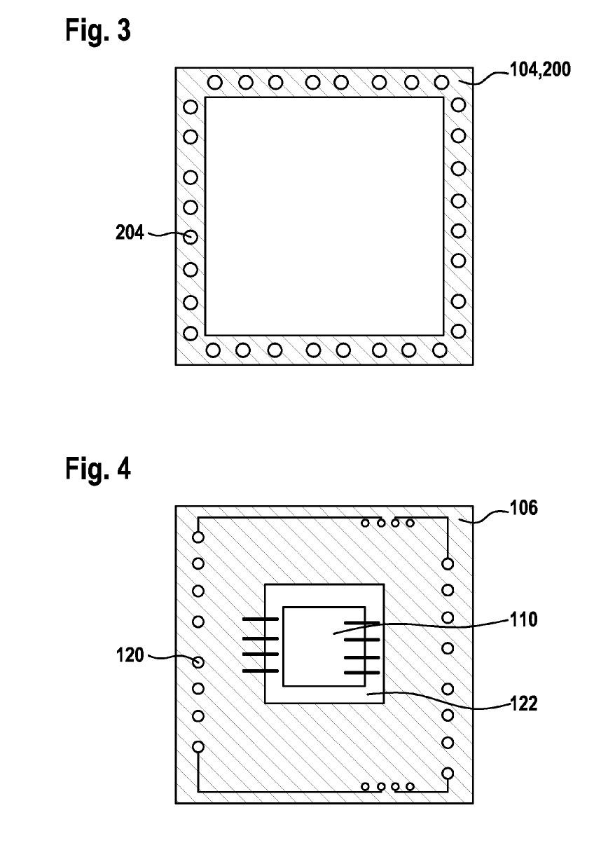

FIG. 3 shows a representation of a central substrate layer according to one exemplary embodiment of the present invention;

FIG. 4 shows a representation of an upper substrate layer having a second sensor element according to one exemplary embodiment of the present invention;

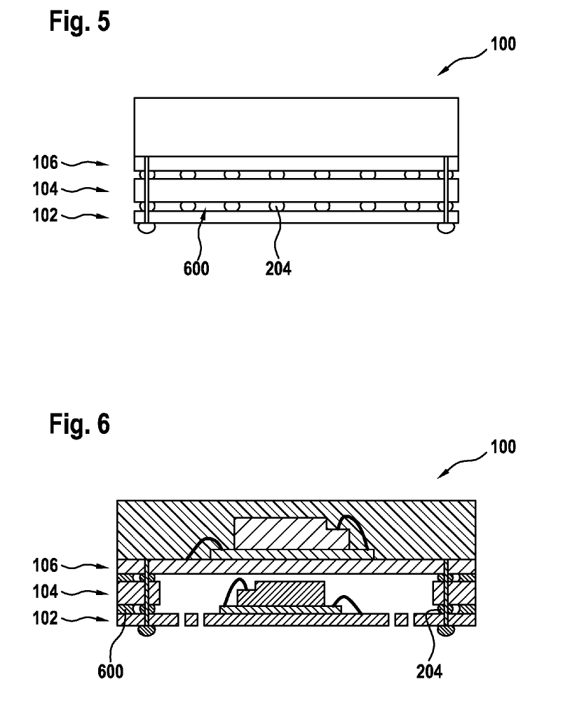

FIG. 5 shows a representation of an inertial sensor having a sealing device made of filler material according to one exemplary embodiment of the present invention;

FIG. 6 shows a representation of an inertial sensor having a sealing device made of solder material according to one exemplary embodiment of the present invention;

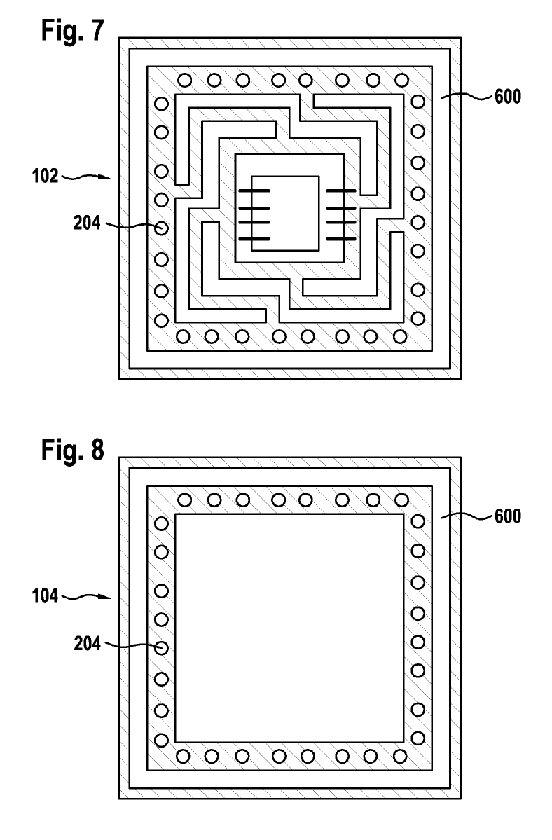

FIG. 7 shows a representation of a lower substrate layer having a sealing device made of solder material according to one exemplary embodiment of the present invention;

FIG. 8 shows a representation of a central substrate layer having a sealing device made of solder material according to one exemplary embodiment of the present invention;

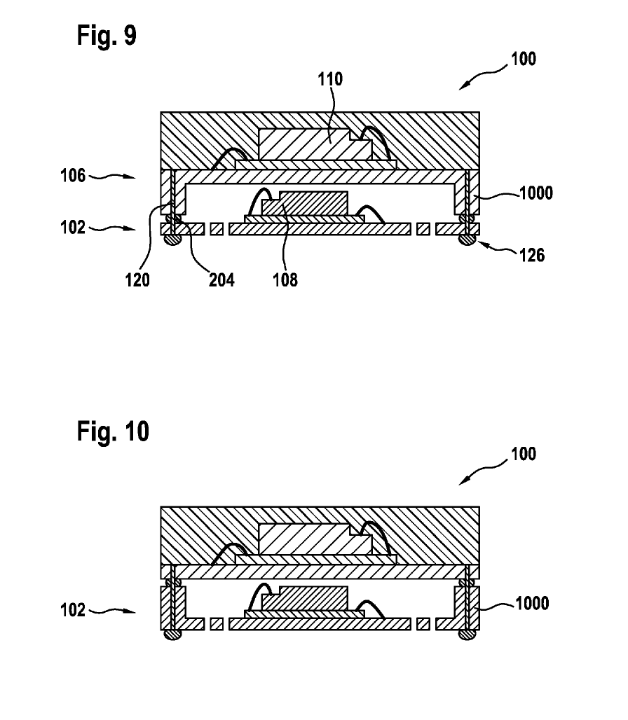

FIG. 9 shows a sectional representation of an inertial sensor having a circumferential foot on the upper substrate plane according to one exemplary embodiment of the present invention;

FIG. 10 shows a sectional representation of an inertial sensor having a circumferential foot on the lower substrate plane according to one exemplary embodiment of the present invention;

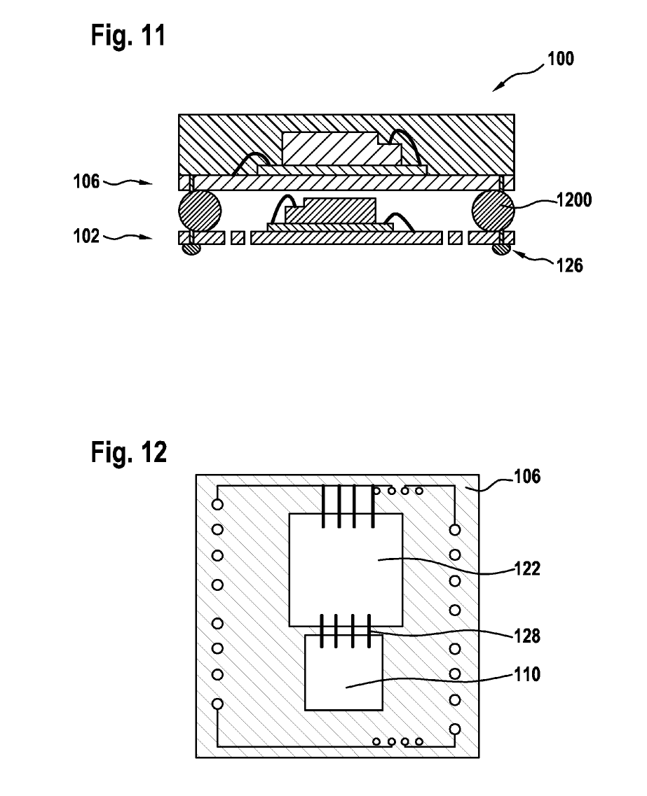

FIG. 11 shows a sectional representation of an inertial sensor having a connection of the lower substrate plane to the upper substrate plane by solder balls according to one exemplary embodiment of the present invention;

FIG. 12 shows a representation of an upper substrate layer having a second sensor element and evaluation electronics, which are arranged next to one another, according to one exemplary embodiment of the present invention;

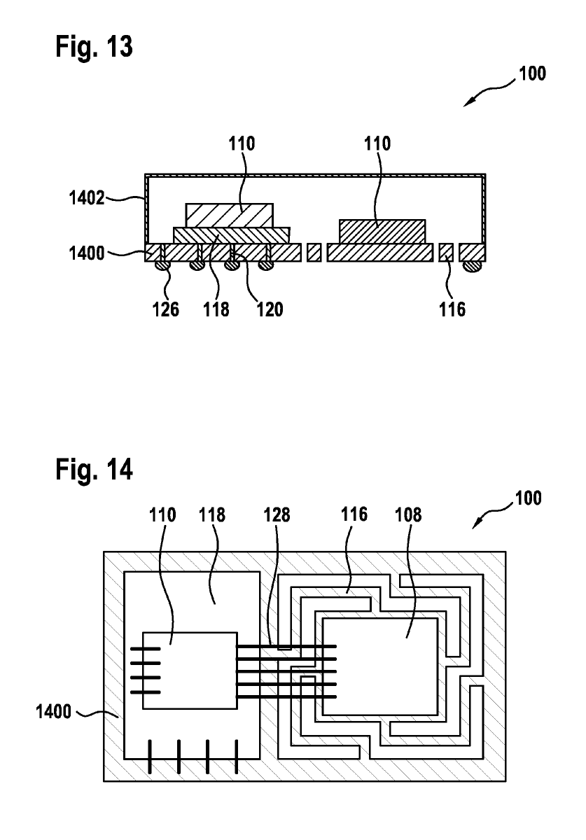

FIG. 13 shows a sectional representation of an inertial sensor having a damped first sensor element and an undamped second sensor element on a substrate plane according to one exemplary embodiment of the present invention;

FIG. 14 shows a representation of an upper side of an inertial sensor having a damped first sensor element and an undamped second sensor element on a substrate plane according to one exemplary embodiment of the present invention; and

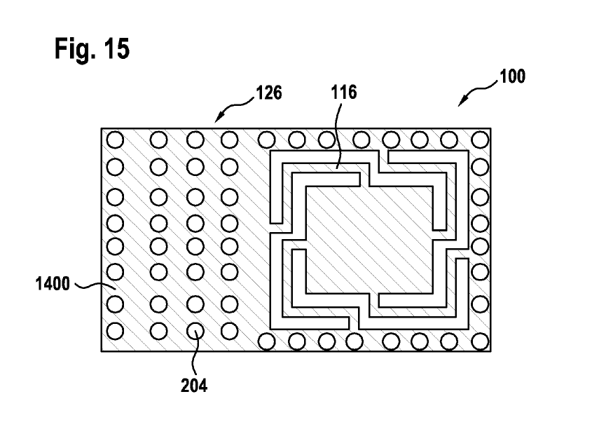

FIG. 15 shows a representation of a lower side of an inertial sensor having a damped first sensor element and an undamped second sensor element on a substrate plane according to one exemplary embodiment of the present invention.

In the description below of expedient exemplary embodiments of the present invention, identical or similar references are used for the elements represented in the various figures which have similar effects, repeated description of these elements being omitted.

FIG. 1 shows the detailed structure of an inertial sensor 100 according to one exemplary embodiment of the present invention. The inertial sensor 100 has a damper system. The overall system 100 consists of three parts 102, 104, 106, a lower substrate layer 102, here having a sensor 108, a central substrate layer 104 for electrical and mechanical connection, and an upper substrate layer 106, and having a further sensor 110.

In this case, a substrate layer may contain a plurality of metallization planes and vias.

The lower substrate layer 102 consists of an island 112, which is circumferentially enclosed by a ring 114. The island 112 and the ring 114 are mechanically and electrically connected to one another by means of spring legs 116 consisting of circuit board material. On the island 112 of the lower substrate layer 102, there is at least one microelectromechanical sensor element (MEMS) 108, which is configured in this case as a rotation rate sensor 108, and optionally an application-specific integrated circuit (ASIC) 118 for evaluation.

In one exemplary embodiment, the evaluation is carried out by means of only one common ASIC, which may be arranged on the upper substrate plane 106 or the lower substrate plane 102. Here, only one ASIC is installed in the entire system 100.

By suitable configuration of the beam-like structures 116, which will also be referred to below as spring legs 116, external mechanical vibrations in a certain frequency spectrum are transmitted to the island 112 only in a damped fashion. The lower substrate layer 102 is electrically and mechanically connected by soldering to a further circuit board (for example a controller). The specific shape of the spring legs 116 is arbitrary. Here, only one variant is shown by way of example. The MEMS 108 and/or ASICs 118 are mechanically and electrically connected to the island 112 by means of adhesive bonding and wire bonding or flip-chip soldering or conductive adhesive bonding. The chips 118 on the island may be protected from environmental influences by a glob top.

The central substrate layer 104 contains electrical vias 120 and optionally electrical lines. It is furthermore used for electrical and mechanical connection of the upper 106 and lower 102 substrate layers, wherein it simultaneously ensures the necessary stand-off of the upper substrate layer 106 from the MEMS 108 and/or ASIC 118 on the lower substrate layer 102. The individual substrate layers 102, 104, 106 are mechanically and electrically connected to one another by a suitable joining process (for example soldering).

The upper substrate layer 106 consists of a circuit board having metallization surfaces and at least one MEMS 110 and/or at least one ASIC 122, which are likewise mechanically and electrically connected to the lower substrate layer 102 and the island 112 by means of adhesive bonding and wire bonding or flip-chip soldering or conductive adhesive bonding. The sensors 110 on the upper side may be protected by means of thermoset injection molding of molding compound 124 or by a cover 124.

In particular, FIG. 1 shows a sectional representation of an inertial sensor 100 according to one exemplary embodiment of the present invention. The inertial sensor 100 has a first sensor element 108 and a second sensor element 110. The first sensor element 108 is mounted in a vibrationally damped fashion in relation to an interface 126 of the inertial sensor 100 by means of a damping element 116. The first sensor element 108 is configured in order to detect a first measurement quantity in a first frequency band. The damping element 116 is configured in order to damp vibrations at least in the first frequency band.

The second sensor element 110 is mechanically coupled to the interface 126. The second sensor element 110 is configured in order to detect a second measurement quantity in a second frequency band.

In one exemplary embodiment, the second sensor element 110 is coupled without damping to the interface 126.

In one exemplary embodiment, the damping element 116 is configured as a flexible beam structure 116 which connects a part 200, coupled to the interface 126, of the inertial sensor 100 to a vibratable part 112 of the inertial sensor 100, the first sensor element 108 being connected to the vibratable part 112.

In one exemplary embodiment, the beam structure 116 bridges a gap which is arranged between an annularly circumferential ring, coupled to the interface 126, of the inertial sensor 100 and a vibratable island 112.

In one exemplary embodiment, a beam 116 of the beam structure 116 connects a side surface of the island 112 to an inner surface, oriented transversely to the side surface, of the ring.

In one exemplary embodiment, the inertial sensor 100 has a first substrate layer 102 and at least a second substrate layer 106, the substrate layers 102, 106 being arranged in different planes, and the first sensor element 108 being arranged on the first substrate layer 102 and the second sensor element 110 being arranged on the second substrate layer 106.

In one exemplary embodiment, at least one central substrate layer 104 is arranged between the first substrate layer 102 and the second substrate layer 106, the central substrate layer 104 separating the first substrate layer 102 from the second substrate layer 106 and forming a cavity between the first substrate layer 102 and the second substrate layer 106.

In one exemplary embodiment, the substrate layers 102, 104, 106 are connected to one another by means of solder balls, the solder balls forming an electrical contact and/or a mechanical contact.

In one exemplary embodiment, the first sensor element 108 is a rotation rate sensor 108 and the second sensor element 110 is an acceleration sensor 110.

In one exemplary embodiment, the first sensor element 108 is an acceleration sensor 108 and the second sensor element 110 is a rotation rate sensor 110.

In one exemplary embodiment, the sensor elements 108, 110 and/or the electrical circuits 118, 122 are connected to the substrate layers 102, 106 by bonding wires 128.

In one exemplary embodiment, the substrate layers 102, 104, 106 are formed from a substrate 130.

In one exemplary embodiment, the first sensor element 108 and/or the second sensor element 110 has an integrated circuit 118, 122 for processing sensor signals of the first sensor element 108 and/or of the second sensor element 110.

In other words, FIG. 1 shows a package stack for selective damping of inertial sensors 108, 110.

A similar effect may be achieved when the first-level module is integrated on a mechanical damper or premold packages with an integrated damper are used. These approaches, however, are not satisfactory and economical for modern molded packages.

In the approach described here the first sensor element 108 is decoupled by a vibration decoupling system. The vibration decoupling system is composed of an inner substrate part 112 and an annular outer substrate part, the two substrate parts being connected by means of beam-like structures 116. The vibration decoupling system is mounted below a substrate 106 of the second sensor element 110 and decouples the first sensor element 108 from parasitic vibrations coming from the next plane, for example a controller. This is therefore vibration decoupling on the 1^{st}-level substrate plane.

The spring structure 116 proposed here is advantageous for the damping of a rotation rate sensor 108, since the spring structure 116 leads to strong damping at the working frequency of the rotation rate sensor 108.

FIG. 2 shows a representation of a lower substrate layer 102 having a damping element 116 and a first sensor element 108 according to one exemplary embodiment of the present invention. The lower substrate layer 102 or substrate plane 102 corresponds essentially to the lower substrate layer in FIG. 1. The lower substrate layer 102 is configured as an annularly closed edge 200, which is separated from the island 112 by a gap 202. The edge 200 is in this case of square shape and has a multiplicity of electrical and/or mechanical contact locations 204. The contact locations 204 are configured as solder balls 204. The contact locations 204 are arranged circumferentially in a single row along the edge 200. The island 112 is in this case likewise of square shape. The gap 202 is circumferentially of uniform width. The gap 202 is bridged by four beam structures 116. Each beam structure 116 connects an inner side of the edge 200 and outer side, arranged transversely thereto, of the island 112. In this case, the beam structure 116 has a meandering shape. In the exemplary embodiment represented, the beam structure 116 has three right-angled bends. The four beams 116 of the beam structure 116 together form essentially a ring which is concentric with the edge 200 and is arranged inside the gap 202. The ring is in this case slotted four times. The four parts of the ring each have a connection to the edge 200 at a first end and a connection to the island 112 at an opposite second end. Metal structures, which are used as conductive tracks for connecting the first sensor element 108 and/or for influencing a spring constant of the beam structures 116, are arranged inside the beams 116. The first sensor element 108 is arranged centrally on the island 112. The first evaluation electronics 118 are likewise arranged centrally on the island 112 between the first sensor element 108 and the lower substrate layer 102. The sensor element 108 and the evaluation electronics 118 are electrically connected to at least one selection of the contact locations 204 by means of the conductive tracks in the beam structures.

FIG. 3 shows a representation of a central substrate layer 104 according to one exemplary embodiment of the present invention. The central substrate layer 104 corresponds essentially to the central substrate layer in FIG. 1. The central substrate layer 104 corresponds essentially to the edge of the lower substrate layer in FIG. 2. As in FIG. 2, the edge 200 of the central substrate layer 104 has a multiplicity of electrical and/or mechanical contact locations 204. The contact locations 204 are configured as solder balls 204. The contact locations 204 are arranged circumferentially in a single row along the edge 200. The contact locations 204 are arranged in correspondence with the contact locations of the lower substrate layer.

FIG. 4 shows a representation of an upper substrate layer 106 having a second sensor element 110 according to one exemplary embodiment of the present invention. The upper substrate layer 106 corresponds essentially to the upper substrate layer in FIG. 1. Like the lower substrate layer in FIG. 2 and the central substrate layer in FIG. 3, the upper substrate layer 106 is square in this case. The dimensions of the upper substrate layer 106 correspond to the lower and central substrate layers. In correspondence with the contact locations represented in FIGS. 2 and 3, the upper substrate layer 106 also has electrical and/or mechanical contact locations. The contact locations are fed by means of through-contacts 120 onto an upper side, represented here, of the upper substrate layer 106. The second sensor element 110 and the evaluation electronics 122 are electrically connected to the through-contacts 120 by means of conductive tracks in the upper substrate layer 106.

The exemplary embodiments shown here present an economical and compact module construction and connection technique for decoupling vibrations in all three spatial directions with the aim of reduced susceptibility of MEMS sensors 108, 110 to interference at the installation position. In comparison with previous approaches, in this case the sensors 108, 110, for example an acceleration sensor 110 and a rotation rate sensor 108, are only selectively decoupled from vibrations, so that a significant performance improvement is obtained.

The module 100 proposed here consists of a plurality of electrically and mechanically connected substrate layers 102, 104, 106, which enclose a cavity. In this case, at least one of the six sides that define the cavity is at least partially open. The lower substrate layer 102 consists of two parts. An island 112 and a circumferentially closed ring 200. The two parts, island 112 and ring 200, are mechanically and electrically connected to one another by means of thin beam-like structures 116. These beam-like structures 116 are configured in such a way that vibrations from the island 112 to the ring 200 or vice versa are decoupled.

The upper substrate layer 106 is mechanically connected rigidly to the circumferentially closed ring 200 of the lower substrate layer 102, and therefore in the installed state to a customer circuit board. No significant vibrational amplifications therefore occur on the upper circuit board 106 at low frequencies, for example about 2 kHz to 5 kHz.

The central substrate layer 104 mechanically and electrically connects the upper substrate layer 106 and the lower substrate layer 102, and may optionally be replaced with solder balls 204.

All the substrate layers 102, 104, 106 contain metallized contact surfaces 204 for electrical and mechanical coupling to the other substrate layers 102, 104, 106, to components or to other circuit boards, such as a controller ESP.

All the substrate layers 102, 104, 106 may contain metallization layers. Furthermore, electrical signals may be fed by means of vias 120 through the individual substrate layers 102, 104, 106.

The upper substrate layer 106 and the lower substrate layer 102 are equipped with at least one MEMS 108, 110/ASIC 118, 122.

The sensor elements 108, 110 and/or the evaluation electronics 118, 122 may be installed by the flip-chip technique. Likewise, the sensor elements 108, 110 and/or the evaluation electronics 118, 122 may be mounted by adhesive bonding and wire bonds 128 or by conductive adhesive bonding. The MEMS 110/ASIC 122 on the upper substrate layer 106 are protected from environmental influences by a molding compound 124 or a cover 124. The MEMS 108/ASIC 118 on the lower substrate plane 102 may be protected from environmental influences by a glob top (on-chip encapsulation).

The approach proposed here provides a compact structure 100 selective decoupling of mechanical vibrations. A high potential for performance enhancement is achieved. In this case, the first sensor element 108, for example a rotation rate sensor 108, is mechanically connected softly. The soft connection is carried out by mounting on the island 112 of the lower substrate layer 102. Conversely, the second sensor element 110, for example an acceleration sensor 110, is connected in a hard fashion. The hard connection is carried out by direct mounting on the upper substrate layer 106. The resulting transfer functions to the sensors 108, 110 are therefore different. The first sensor element 108 therefore has strong damping at 20-30 kHz, while the second sensor element 110 has no vibrational amplification at low frequencies (2-5 kHz).

By virtue of the approach proposed here, an economical acceleration sensor 110 can be used. Interference modes at low frequencies are not to be expected.

An elaborate layout of the damper system 100 can be obviated with the approach proposed here.

The resonant frequency of the spring structure 116 is determined only by the circuit board material and the dimensions. A significant drift as a function of temperature is not to be expected.

The mass on the island 112 of the lower substrate layer 102, composed of a mass of the first sensor element 108 plus the optional evaluation electronics 118, is relatively small, so that the center of mass of this island 112, consisting of the substrate 130 and the sensor element 108 plus the evaluation electronics 118, lies relatively close to the rotation point of the island 112. The system is therefore balanced and an economical sensor 108 with a higher rotational acceleration sensitivity can be used.

Without damping material, the spring system 116 is softer, and the resulting damping for the same spring legs structures is therefore higher for a particular frequency above the resonant frequency of the damper.

In other words, FIGS. 1 to 4 show plan views and a section of the sensor system 100 with selective damping of the second sensor element 108.

FIG. 5 shows a representation of an inertial sensor 100 having a sealing device 600 consisting of filler material according to one exemplary embodiment of the present invention. The inertial sensor 100 corresponds essentially to the inertial sensor in FIG. 1. In addition, a first sealing layer 600 is arranged between the lower substrate layer 102 and the central substrate layer 104. Furthermore, a second sealing layer 600 is arranged between the central substrate layer 104 and the upper substrate layer 106. The sealing layers 600 close intermediate spaces between the solder balls 204, in order to make it more difficult for contaminants to enter the cavity between the lower substrate layer 102 and the upper substrate layer 106.

In one exemplary embodiment, a sealing device 600 for sealing the cavity is arranged between the substrate layers 102, 104, 106.

In the exemplary embodiment represented, the sealing device 600 is made of an electrically insulating filler material 600. The filler material 600 seals the cavity.

For lateral sealing, it is also possible to seal the regions between the solder balls 204 with a filler material 600, in order to protect the system better from dust.

FIG. 6 shows a sectional representation of an inertial sensor 100 having a sealing device 600 consisting of solder material according to one exemplary embodiment of the present invention. The inertial sensor 100 corresponds essentially to the inertial sensor in FIG. 1. In addition, a first solder ring 600 is arranged as a sealing device 600 between the lower substrate layer 102 and the central substrate layer 104. Furthermore, a second solder ring 600 is arranged as a sealing device 600 between the central substrate layer 104 and the upper substrate layer 106. The solder rings 600 are arranged outside the contact devices 204 and are separated therefrom. The solder rings 600 are therefore electrically insulated from the contact devices 204. As in FIG. 6, the solder rings 600 seal the cavity between the lower substrate layer 102 and the upper substrate layer 106 against ingress of foreign bodies.

FIG. 7 shows a representation of a lower substrate layer 102 having a sealing device 600 consisting of solder material according to one exemplary embodiment of the present invention. The lower substrate layer 102 corresponds essentially to the lower substrate layer in FIG. 7. The sealing device 600 is configured as an annularly circumferential solder ring 600 externally around the contact devices. The solder ring 600 provides an additional mechanical and/or electrical connection to the central or upper substrate plane.

FIG. 8 shows a representation of a central substrate layer 104 having a sealing device 600 consisting of solder material according to one exemplary embodiment of the present invention. The central substrate layer 104 corresponds essentially to the central substrate layer in FIG. 7. The sealing device 600 is configured as an annularly circumferential solder ring 600 externally around the contact devices. The solder ring 600 provides an additional mechanical and/or electrical connection to the upper and/or lower substrate plane.

Alternative lateral sealing may also be achieved when, in addition to the solder balls 204, a solder ring 600 extending circumferentially on both sides is placed on the central substrate plane 104.

FIG. 9 shows a sectional representation of an inertial sensor 100 having a circumferential foot 1000 on the upper substrate plane 106 according to one exemplary embodiment of the present invention. The inertial sensor 100 corresponds essentially to the inertial sensor in FIG. 1. In contrast thereto, the inertial sensor merely has a lower substrate layer 102 and an upper substrate layer 106. The upper substrate layer has a circumferential foot 1000, which produces a plane offset of the contact devices 204 from a lower side of the upper substrate layer 106. Because of the plane offset, the upper substrate layer 106 is separated from the lower substrate layer 102 in the region of the sensor elements 108, 110. The cavity is arranged between the substrate layers 102, 106. Through-contacts 120 for electrically connecting the second sensor element 110 to the interface 126 extend through the foot 1000.

FIG. 10 shows a sectional representation of an inertial sensor 100 having a circumferential foot 1000 on the lower substrate plane 102 according to one exemplary embodiment of the present invention. The inertial sensor 100 corresponds essentially to the inertial sensor in FIG. 10. In contrast thereto, in this case the foot 1000 is a component of the lower substrate plane 102.

In one exemplary embodiment, at least one of the substrate layers 102, 106 has an annularly circumferential foot 1000 in order to define a distance between the substrate layers 102, 106 and to form the cavity.

With a suitable configuration of the upper substrate layer 106 and the lower substrate layer 102, the central substrate layer can be omitted. The blind-hole configuration shown may be produced by deep milling or by pressing with no-flow prepreg.

FIG. 11 shows a sectional representation of an inertial sensor 100 having a connection of the lower substrate plane 102 to the upper substrate plane 106 using solder balls according to one exemplary embodiment of the present invention. The inertial sensor 100 corresponds essentially to the inertial sensor in FIG. 1. In contrast thereto, the inertial sensor merely has a lower substrate layer 102 and an upper substrate layer 106. The central substrate layer is replaced with solder balls 1200. The solder balls 1200 have a larger diameter than the solder balls of the interface 126. Because of the diameter of the solder balls, the lower substrate layer 102 and the upper substrate layer 106 are kept at a predetermined distance from one another. The distance defines a height of the cavity of the sensor 100.

If the MEMS 108/ASIC 118 on the island of the lower substrate layer 102 have a sufficiently small overall height. Then it is also possible to use solder balls 1200 having an adapted diameter in order to produce the stand-off of the upper substrate layer 106.

FIG. 12 shows a representation of an upper substrate layer 106 having a second sensor element 110 and evaluation electronics 122, which are arranged next to one another, according to one exemplary embodiment of the present invention. The upper substrate layer 106 corresponds essentially to the upper substrate layer in FIG. 4. In contrast thereto, both the evaluation electronics 122 and the second sensor element 110 are arranged directly on the upper substrate layer 106. The second sensor element 110 is connected to the evaluation electronics 122 by means of wire bonds 128.

FIG. 12 shows a further embodiment, which shows an alternative arrangement of the MEMS 110/ASIC 122. It is not necessary to provide any area on the upper substrate layer 106 for structuring the beam-like structures, so that the usable area for the fitting of MEMS 110/ASIC 122 is larger in comparison with the lower substrate layer. For this reason, for example, the MEMS 110/ASIC 122 do not need to be “stacked” on one another but can be arranged next to one another, so that the overall height of the entire damper system is reduced.

FIG. 13 shows a sectional representation of an inertial sensor 100 having a damped first sensor element 108 and an undamped second sensor element 110 on a substrate plane 1400 according to one exemplary embodiment of the present invention. Evaluation electronics 118 are arranged between the second sensor element 110 and the substrate layer 1400. The first sensor element 108 is, as described in FIG. 1, damped by a damping structure 116. The damping structure 116 is produced from the substrate layer 1400. The damping structure 116 corresponds essentially to the damping structure described in the previous exemplary embodiments. The substrate plane 1400 has through-contacts 120, which connect the evaluation electronics 118 to an interface 126 on an opposite side of the substrate plane 1400. The inertial sensor 100 has a cover 1402, which encloses a cavity in which the first sensor element 108, the second sensor element 110 and the evaluation electronics 118 are arranged. The first sensor element 108 lies at a distance from the cover 1402 in order to be capable of vibrating.

In one exemplary embodiment, the first sensor element 108 and the second sensor element 110 are arranged on a substrate 1400.

Besides the approach, described so far, of stacking elements, the rotation rate sensor 108 and the acceleration sensor 110 may also be constructed next to one another on a plane 1400. In this case, the substrate 1400 is housed with a cover 1402, for example made of plastic or metal.

The rotation rate sensor 108 is arranged on the island 112 and is connected by wire bonds 128 directly to an ASIC 118 on the substrate side that is connected in a hard fashion. As an alternative, the first sensor element 108 and an extra ASIC may be arranged on the island 112. The electrical connection may extend through the spring legs 116 to the solder balls 204 in the frame. Likewise, it is possible for only the first sensor element 108 to be arranged on the island 112. Wire bonds 128 may extend from the first sensor element 108 onto the island 112. From there, interconnection may be carried out via the spring legs 116 to the frame. Flip-chip mounting of the sensors 108, 110 is likewise possible.

Regardless of the electrical contacting of the first sensor element 108, the spring legs 116 may contain copper, even when wire bonds 128 extend from the first sensor element 108 directly to the ASIC 118. The copper may be used in order to influence the resonant frequency and the vibrational amplification of the spring/mass system. Likewise, an additional cover may be arranged over the subregion of the island structure 112 as particle protection of the lower side.

FIG. 14 shows a representation of an upper side of an inertial sensor 100 having a damped first sensor element 108 and an undamped second sensor element 110 on a substrate plane 1400 according to one exemplary embodiment of the present invention. The inertial sensor 100 corresponds essentially to the inertial sensor in FIG. 14. Here, the structure of the damping element 116 is shown in accordance with the representation in FIG. 2. In addition to the first sensor element 108, mounted with the vibrational damping by the damping element 116, the undamped second sensor element 110 and the evaluation electronics 118 arranged on the substrate plane 1400. The first sensor element 108 is connected directly to the evaluation electronics 118 by wire bonds 128. The wire bonds 128 bridge the damping element 116 directly.

FIG. 15 shows a representation of a lower side of an inertial sensor 100 having a damped first sensor element and an undamped second sensor element on a substrate plane 1400 according to one exemplary embodiment of the present invention. The inertial sensor 100 corresponds essentially to the inertial sensor in FIG. 14. Here, the interface 126, which ensures an electrical contact and alternatively or in addition a mechanical contact of the inertial sensor 100 to a fastening surface, is represented. Here, the interface 126 is formed in the region of the evaluation electronics as a grid of solder balls 204. In the region of the damping element 116, the interface is configured as a line, extending in a single row around the damping element 116, of solder balls 204. In the region of the evaluation electronics, the interface 126 provides both the mechanical contact and the electrical contact. In the region of the damping element 116, the interface 126 provides in particular the mechanical contact.

The exemplary embodiments described and shown in the figures are selected only by way of example. Different exemplary embodiments may be combined with one another fully or in respect of individual features. One exemplary embodiment may also be supplemented with features of another exemplary embodiment.

Furthermore, the method steps proposed here may be carried out repeatedly as well as in an order other than that described.

If an exemplary embodiment contains an “and/or” conjunction between a first feature and a second feature, this is to be interpreted as meaning that the exemplary embodiment has both the first feature and the second feature according to one embodiment, and either only the first feature or only the second feature according to another embodiment.

1. An inertial sensor comprising:
an interface;
a first sensor element, which is vibrationally damped in relation to the interface by a damping element, the first sensor element being configured to detect a first measurement quantity in a first frequency band and the damping element being configured to damp vibrations in at least the first frequency band; and
a second sensor element, which is mechanically coupled to the interface, the second sensor element being configured to detect a second measurement quantity in a second frequency band.

2. The inertial sensor as claimed in claim 1, wherein the second sensor element is coupled without damping to the interface.

3. The inertial sensor as claimed in claim 1, wherein:
the damping element is a flexible beam structure which connects a part, coupled to the interface, of the inertial sensor to a vibratable part of the inertial sensor, and
the first sensor element is connected to the vibratable part.

4. The inertial sensor as claimed in claim 3, wherein:
the beam structure bridges a gap which is arranged between an annularly circumferential ring, coupled to the interface, of the inertial sensor and a vibratable island, and
a beam of the beam structure connects a side surface of the island to an inner surface of the ring, the inner surface oriented transversely to the side surface.

5. The inertial sensor as claimed in, claim 1, further comprising:
a first substrate layer and a second substrate layer, the substrate layers being arranged in different planes,
wherein the first sensor element is arranged on the first substrate layer and the second sensor element is arranged on the second substrate layer.

6. The inertial sensor as claimed in claim 5, further comprising:
at least one central substrate layer arranged between the first substrate layer and the second substrate layer, the at least one central substrate layer separating the first substrate layer from the second substrate layer and forming a cavity between the first substrate layer and the second substrate layer.

7. The inertial sensor as claimed in claim 5, wherein:
the substrate layers are connected to one another by solder balls, and
the solder balls form at least one of an electrical contact and a mechanical contact.

8. The inertial sensor as claimed in claim 6, further comprising:
a sealing device configured to seal the cavity, the sealing device arranged between the substrate layers.

9. The inertial sensor as claimed in claim 6, wherein at least one of the substrate layers has an annularly circumferential foot configured to define a distance between the substrate layers and form the cavity.

10. The inertial sensor as claimed in claim 1, wherein the first sensor element and the second sensor element are arranged on a substrate.

11. The inertial sensor as claimed in, claim 1, wherein at least one of the first sensor element and the second sensor element has an integrated circuit configured to process sensor signals of at least one of the first sensor element and the second sensor element.

12. The inertial sensor as claimed in, claim 1, wherein one of the first sensor element and the second sensor element is a rotation rate sensor and the other of the first sensor element and the second sensor element is an acceleration sensor.
